(19) United States
(12) Patent Application Publication
(10) Pub. No.: US 2003/0135633 A1
(43) Pub. Date: Jul. 17, 2003

(54) Streaming and managing complex media content on Web servers

(75) Inventors: Orell Dror, Haifa (IL); Zohar Sivan, Zichron Yaakov (IL)

Correspondence Address: BROWDY AND NEIMARK, P.L.L.C., 624 NINTH STREET, NW, SUITE 300, WASHINGTON, DC, 20001-5303, US

(73) Assignee: INTERNATIONAL BUSINESS MACHINES CORPORATION, Armonk, NY (US)

(21) Appl. No.: 10/035,321

(22) Filed: Jan. 4, 2002

(51) Int. Cl. G06F 15/16; H04N 7/16

(52) U.S. Cl. 709/231; 725/141; 709/218

(57) ABSTRACT

A method for using a Java-based servlet running on a HTTP server to stream media content to a client. The method allows a servlet to optionally modify a media file, and to specify the byte range within the file to stream to the client.

### FIELD OF THE INVENTION

The present invention relates generally to streaming media over the internet, and specifically to the use of a HTTP server to stream media.

### BACKGROUND OF THE INVENTION

The complexity of media delivered while browsing the Internet is increasing. Web sites increasingly offer not only text and images, but also more complex media such as audio and video segments, and virtual reality spaces in which users can interact with their surroundings.

Concurrently, users may visit Web sites via a large diversity of devices, possessing different levels of computational power, connection bandwidth, and user interface capabilities. Users browse the Internet with cellular phones, Personal Data Assistants (PDAs) and television sets, as well as high-resolution monitors on top-of-the-line computers. There are methods and systems known in the art for streaming complex media over networks such as the Internet, as well as for adapting the streamed media to the available bandwidth and the resources of the user device. These systems are typically based on costly, complex media servers that are developed and deployed especially for this purpose.

Content developers create information to be delivered over the Internet by encoding the information into files in standard media formats. The file formats are specified by recognized standards. MPEG-4 is a versatile file format for encoding audio and video media. It is described, for example, by Koenen in “Overview of the MPEG-4 Standard,” published by the International Organisation for Standardisation as document ISO/IEC JTC1/SC29/WG11 (March 2001), which is incorporated herein by reference. This document is available at www.cselt.it/mpeg/standards/mpeg-4. The standard supports scalable multimedia content, that is, it allows content to be encoded once and automatically played out at different bitrates as appropriate for the user's communication device.

The MPEG-4 standard also provides mechanisms to describe and synchronize multimedia streams. At the lowest level, each audio or visual component is known as an object. The objects are composed into a scene. Each object is described mathematically and given a position in 3-D space, as well as a temporal relation to the other objects. The standard supports methods for synchronizing the different objects in a scene. A device used to decode and display the streams may ignore objects that are not appropriate for the device. For instance, low-resolution devices may choose to ignore small objects.

Web servers and clients typically communicate over a network using the Hypertext Transfer Protocol (HTTP). The clients request information by submitting a HTTP request with a Universal Resource Location (URL) specifier. There are standard extensions to Web servers known in the art that allow a Web server to delegate handling of particular URLs to a separate task. The advantage to such an arrangement is its modularity. Upgrading the handling of a particular type of URL requires only the replacement of the server extension, without requiring an upgrade to the server itself. Additional functionality can be provided in such extensions as well, for instance on-line generation of information to be returned to the client.

One of the standard methods to extend Web servers is through servlets written in the Java™ programming language. A standard method of creating servlets is set forth by Coward in the “Java Servlet Specification Version 2.3,” (Sun Microsystems, Inc., Palo Alto, Calif., April, 2001), which is incorporated herein by reference. This document is available at java.sun.com/j2ee/servlet. Tomcat is an implementation of Java Servlet technology developed under the Jakarta project at the Apache Software Foundation. A software development kit (SDK) for developing servlets using Tomcat is available at jakarta.apache.org, and is incorporated herein by reference. The advantage of using servlets is their portability. Source code for a servlet need only be created once. Theoretically, it will then run on all Web servers and all computer platforms that support servlet containers.

An example of the use of servlets in downloading images from a HTTP server to a client is described in U.S. Pat. No. 6,281,874, which is incorporated herein by reference. In this application, a Java servlet runs constantly in the background on a HTTP server and monitors requests from clients for image downloads. When a client request is received by the HTTP server, the servlet extracts a high-resolution image from an image database, and calls an image processor to perform image manipulation on the image. Subsequently, the servlet opens a connection to the client and returns the processed image or saves it to a file and sends the user its URL address.

Multimedia content is commonly delivered to Web clients through proprietary streaming media servers, such as Microsoft Netshow™, Real G2™, Apple Darwin™, or IBM VideoCharger™. Most of these servers require unique, proprietary software clients to decode the stream. The software is provided in a stand-alone application or is embedded into the client's Web browser as a plugin. While the client-side software is usually provided free of charge, there is usually a fee for use of software required to setup a streaming server. Typically, the streaming server uses RTP or UDP instead of HTTP as a transport protocol, due to the high overhead of HTTP. Since by default most firewalls are set up to block UDP and RTP, streaming the aforementioned media formats through a firewall requires specially configuring the firewall or the software.

Kumar et al., for example, describe a proprietary media format and associated Java-based client software, named HotMedia, in “The HotMedia Architecture: Progressive and Interactive Rich Media for the Internet”, published in IEEE Transactions On Multimedia, Vol. 3, No. 2 (June, 2001), which is incorporated herein by reference. HotMedia encapsulates media tracks of various types in frames in a HotMedia file. The standard suffix for a HotMedia file is mvr, thus these files are also known as mvr files. Each file contains many such media frames. In addition, each file has a header frame which includes a description of each media track that is contained in the file, and optionally the class name of the Java-based class that will render the track on the client's Web browser. When the HotMedia software running as a Java-based plug-in within the client's Web browser encounters a new class name, the code needed to instantiate the class is fetched from the server. This allows new media types to be added to the presentation with no changes or additions to the client, so long as the new media type implements the interfaces specified in the HotMedia framework. HotMedia files may also include meta frames, which specify non-media specific contextual information used in the presentation of the media frames. For instance, a meta frame may specify the spatial-temporal context synchronizing two media frames, or may indicate action to be taken when a client receives a mouse click within a media frame.

### SUMMARY OF THE INVENTION

Preferred embodiments of the present invention provide generalized methods for creating and using a servlet to stream parts of a media file to a client device, preferably in conjunction with a standard HTTP server. The servlet responds to a client request for complex media, such as video or sound, by analyzing the request, identifying the required media file, and determining any processing to be performed on the media file before streaming it to the client. The servlet then extracts the appropriate portions of the media file, and returns them to the HTTP server to stream to the client.

Preferably, the client can interact with the media content by sending requests to the servlet, which translates the requests into actual processing of the media. Exemplary requests include:

seeking to a specific location in the media file, and streaming from the location without streaming previous parts of the file;

transmitting only some portions of a media file composed of several related streams or objects.

transcoding the content of the media file, so as to adapt the output stream to the network channel and the specific client platform or to translate the media file from one format to another.

Preferred embodiments of the present invention thus enable highly-efficient streaming of media content by transmitting only what the client requested or is capable of playing, which can be only a small subset of a complex media file. The media file is preferably stored in a form that allows portions of it to be extracted and streamed by the servlet. These preferred embodiments are implemented in a HTTP streaming environment that is based on standard HTTP servers, rather than requiring costly, specialized media servers. The servlet is highly portable since it conforms to a standard application interface (API) which is implemented by servlet containers that are available for most common HTTP servers. This method provides a generic framework for handling a variety of media file formats.

There is therefore provided, in accordance with a preferred embodiment of the present invention, a method for media streaming, including:

receiving a request from a client to a server via a network in accordance with a Hypertext Transfer Protocol (HTTP) to stream a media file of a given type;

passing the request to a servlet running in conjunction with the server;

parsing the request using the servlet to identify elements of the media file to be transferred to the client; and

streaming the identified elements from the server to the client as a HTTP response.

Preferably, parsing the request includes determining a processing action to be applied to the elements of the media file, and streaming the identified elements includes applying the processing action to the elements.

Further preferably, parsing the request includes determining a parameter applicable to the processing action, and applying the processing action includes processing the elements of the media file responsive to the parameter.

Preferably determining the parameter includes determining a limitation on a media playing capability of the client, and the processing action includes modifying the identified elements in response to the limitation.

Preferably, determining the limitation includes identifying a network bandwidth, and modifying the identified elements in response to the limitation includes altering the elements responsive to the network bandwidth.

More preferably, determining the limitation includes determining a resource level provided by the client, and modifying the identified elements includes selecting the identified elements responsive to the resource level.

Additionally or alternatively, applying the processing action includes transcoding at least one of the elements of the media file into a desired media format.

Alternatively, receiving the request includes receiving a request for a certain portion of the media file, and parsing the request includes selecting the elements of the media file to be transferred responsive to the request.

Preferably, the elements of the media file include an ordered sequence of frames, and selecting the elements includes selecting a segment within the sequence.

More preferably, the elements of the media file includes a plurality of media tracks temporally juxtaposed in parallel, and selecting the elements includes selecting one or more of the tracks.

There is additionally provided, in accordance with a preferred embodiment of the present invention, apparatus for media streaming, including a server which is arranged to receive a request from a client via a network in accordance with a Hypertext Transfer Protocol (HTTP) to stream a media file of a given type, and which is further arranged to run a servlet and to pass the request to the servlet, to parse the request using the servlet to identify elements of the media file to be transferred to the client, and to stream the identified elements from the server to the client as a HTTP response.

Preferably, the server includes a cluster of servers, arranged so that the HTTP request is handled by one of the servers in the cluster, and the servlet is run on a different one of the servers in the cluster.

There is also provided, in accordance with a preferred embodiment of the present invention, a computer software product for media streaming, including a computer-readable medium in which program instructions are stored, which instructions, when read by a computer, cause the computer to receive a request from a client via a network in accordance with a Hypertext Transfer Protocol (HTTP) to stream a media file of a given type, and which instructions further cause the computer to run a servlet and to pass the request to the servlet, to parse the request using the servlet to identify elements of the media file to be transferred to the client, and to stream the identified elements from the server to the client as a HTTP response.

Preferably, the servlet includes a subset of the instructions, and the subset of the instructions includes instructions written in a platform-independent, object-oriented computer language.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a system for streaming media files to a client via a server, in accordance with a preferred embodiment of the present invention; and

FIG. 2 is a flow chart that schematically illustrates a method for processing a client request for streamed media using a servlet, in accordance with a preferred embodiment of the present invention.

### DETAILED DESCRIPTION OF PREFERRED EMBODIMENTS

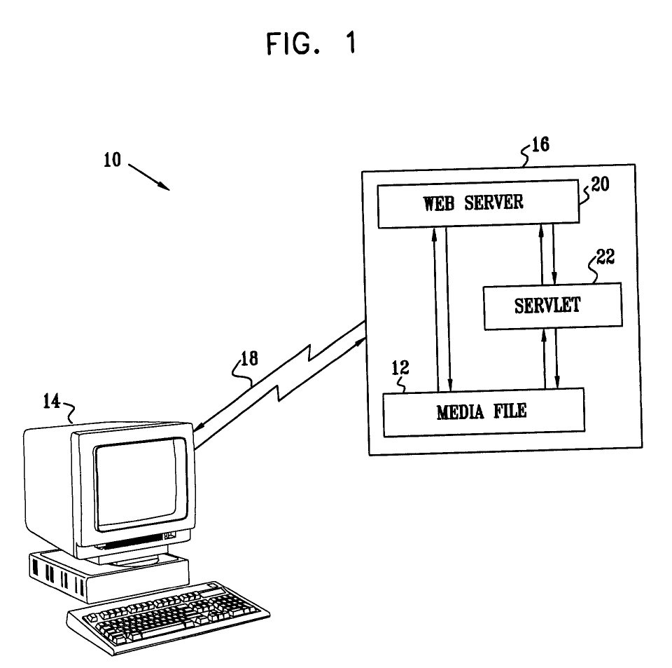

FIG. 1 is a block diagram that schematically illustrates a system 10 for streaming a media file 12 to a client 14 via a server 16, in accordance with a preferred embodiment of the present invention.

Client 14 and server 16 communicate over a network 18. Network 18 is characterized by a bandwidth and a latency of transmission, which may vary over time. Typically, network 18 is the Internet. Client 14 may comprise any computing device that includes a suitable connection to network 18, for instance a computer, a PDA, or a cellular phone, and has suitable client software for playing streamed media files 12, such as audio, video and/or animation files. Preferably, the client software comprises a standard Web browser of a type appropriate to the client platform with suitable applets or other extensions to the browser that enable the browser to play streamed media files. Alternatively or additionally, the client software may comprise a stand-alone application. Client 14 sends media requests to server 16 using HTTP as a communication protocol. Each request comprises a label indicating the media file. The request may further indicate an action to be performed on the media file.

Server 16 comprises a computer or cluster of computers with a suitable connection to network 18 running Web server software 20, as is known in the art. This software enables server 16 to communicate with the client using HTTP requests and responses. Web server 20 examines the media request sent by client 14, and takes action accordingly. Web server 20 is configured so that requests for media file 12 are passed on to a servlet 22, as described in the above-mentioned specification by Coward. Servlet 22 may run on the same computer as Web server 20, or it may alternatively run on another computer in the cluster. Servlet 22 parses the client request and responds by extracting portions of media file 12 to be sent to client 14. Web server 18 then streams portions of the media file back to client 14.

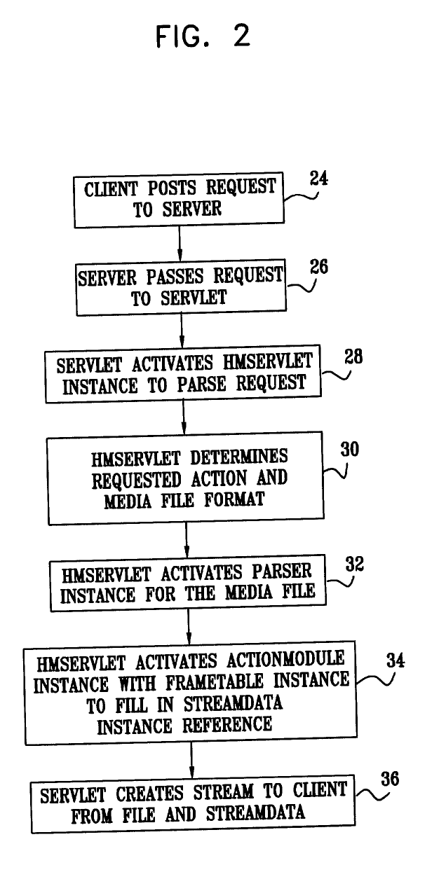

Table 1 is a class hierarchy for an implementation of servlet 22 in the Java programming language, in accordance with a preferred embodiment of the present invention. This embodiment is directed specifically to MVR-type media files, but the principles that it exemplifies can equally be used with other types of media files. Thus, for example, the class “mvrParser” listed below is an instance of an abstract class “mediaParser.” Further notes to the table are given below, and the use of the classes in the table in servicing a media request is described thereafter with reference to FIG. 2.

TABLE 1
Servlet Class Heirarchy

| | |
|---|---|
| Class | Inherits from |

com.ibm.hotmedia.v40.hmservlet

javax.servlet.http.HttpServlet
javax.servlet.Servlet
javax.servlet.ServletConfig

com.ibm.hotmedia.v40.GenericRangeActionjava.lang.Object,

com.ibm.hotmedia.v40.ActionModule

| | |
|---|---|
| com.ibm.hotmedia.v40.TrackFilterAction | java.lang.Object |

com.ibm.hotmedia.v40.ActionModule

| | |
|---|---|
| com.ibm.hotmedia.v40.MvrFrameDescriptor | java.lang.Object |
| com.ibm.hotmedia.v40.MvrFrameTable | java.lang.Object |
| com.ibm.hotmedia.v40.MvrParser | java.lang.Object |
| com.ibm.hotmedia.v40.MvrStreamData | java.lang.Object |
| com.ibm.hotmedia.v40.OutputManager | java.lang.Object |
| com.ibm.hotmedia.v40.StreamRange | java.lang.Object |

The hmservlet class is the request manager. It receives and parses client requests, opens the media file, invokes an instance of a mvrParser class to parse the media file, and invokes an instance of an ActionModule class to handle the requested action on the media file. It also invokes an instance of an OutputManager class to stream the response via Web server 20 to the client.

The mvrParser class parses MVR media files and builds a frame table that mirrors the frames in the file. The mvrParser class includes methods to break the media file into component frames. Each frame type (header, media, or meta, as described in the Background of the Invention) is further parsed so as to extract information into a mvrFrameDescriptor, described below.

The mvrFrameTable class holds information about the media file required for actions to be applied to the file. For every frame in the file, a mvrFrameDescriptor, held in the mvrIndexTable, is filled in with the frame type, its location in the file and other relevant information.

The StreamRange class is a representation of the byte range in the media file that should be streamed to the client. It also provides an addReplacement method for cases in which the byte range is to be modified prior to streaming. For instance, if a header frame specifies a file's size, and the file is modified so as to change its size, the header frame must be modified appropriately before streaming.

The mvrStreamData class encapsulates the information necessary to stream the frames back to the client. It holds a vector of StreamRange instances.

The ActionModule class is an abstract class from which all action modules inherit. Each action module receives a reference to a mvrFrameTable instance from the hmservlet, and inserts information accordingly into a reference to a mvrStreamData class instance. Exemplary action modules include:

The GenericRangeAction class, which responds to a client request for a range of ordinal or temporal frames from the media file.

The TrackFilterAction class, which returns specified tracks from the media file, or eliminates specified tracks from the returned stream.

The OutputManager class extracts the byte ranges indicated in the mvrStreamData instance from the media file, and streams them back to Web server 20 to relay to the client using HTTP.

FIG. 2 is a flow chart that schematically illustrates a method for streaming media from server 16 to client 14 in response to a client request, in accordance with a preferred embodiment of the present invention, using the classes listed in Table 1. The steps of the method are preferably carried out by servlet 22 running in conjunction with Web server 18 on server 16. The servlet and associated software may be supplied to server 16 in electronic form, by downloading over a network, for example, or it may alternatively be supplied on tangible media, such as CD-ROM or non-volatile memory, either independently or as a part of a package with Web server 20 and/or media 12.

The method begins at a request post step 24, whenever client 14 passes a request to Web server 20 via network 18 to retrieve media file 12. Preferably, the client uses the GET method provided by HTTP to form a Universal Request Locator (URL) including the name of the requested media file, and a term defining the action to be taken on the file by the server. For instance, a request to stream a certain range of data in the media file to the client would include the following term: [unit_code] [range_code, range_code]. For example, a request to stream the portion of the file from 4500 milliseconds onward would include the term: range=[ms][4500]. A complete URL to play tracks 104 and 105 from file myfile.mvr, beginning at the 11th second until the end of the file would be:

http://ps43-33.haifa.ibm.com/servlet/hmservlet

?mvrFile=myfile.mvr

&tracks=[i][105,104 ]

&range=[ms][11000-]

(Here the URL is broken into multiple lines for clarity of display. Normally it would appear with no line breaks.)

Web server 20 determines that the URL refers to servlet 22 based on the location of the servlet and the Web server configuration, at a request passing step 26. This sort of URL request parsing is well known in the servlet art, as described, for example, by Coward, in the above-mentioned “Java Servlet Specification.” The Web server passes the request to the servlet for processing.

The servlet activates a hmservlet class instance to parse the client request, at a request parsing step 28, through the inherited Java class function HttpServlet::doGet( ). The hmservlet class inherits the functionality to parse a URL into components from the Java class functions HttpServlet::getQueryString( ), HttpServlet::getParameter( ) and HttpServlet:: getParameterNames( ). The hmservlet class instance further determines the format of the media file and the action requested on the file at a determination step 30.

To carry out the required action, the hmservlet instance instantiates a mediaparser class appropriate for the media file format at a parser instantiation step 32, and passes to it the location of the media file. The mediaparser class inherits its interface from the abstract mediaparser class, but is specified to handle a particular media file format. For instance, upon determining that the requested media file is in the MVR format, the hmservlet instance instantiates a mvrParser class instance, as listed in Table 1 above, with a handle to the media file. The mediaparser class includes methods to break the media file into component frames. The mediaparser instance stores information for each frame in a mediaFrameTable instance, specialized for the media type. Continuing the example from above, the mvrParser instance stores information in a mvrFrameTable class instance.

The hmservlet instance instantiates an actionModule instance using the mediaFrameTable instance and the request parameters, at an actionModule instantiation step 34. The actionModule instance processes the request parameters to output a reference to a mediaStreamData class instance, which specifies the byte range of the media file to return to the client.

At a stream creation step 36, the servlet instantiates and calls an OutputManager class instance to extract the data from the media file according to the mediaStreamData class instance. Web server 20 then streams the data back to client 14 over network 18 in the form of a HTTP response.

Although preferred embodiments described herein are based specifically on the servlet Software Development Kit (SDK) Tomcat, and the interface as described by Coward, it will be evident to those skilled in the art that the principles of the present invention may similarly be implemented using media handling routines written in other programming languages in conjunction with standard Web servers. It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for media streaming, comprising:
receiving a request from a client to a server via a network in accordance with a Hypertext Transfer Protocol (HTTP) to stream a media file of a given type;
passing the request to a servlet running in conjunction with the server;
parsing the request using the servlet to identify elements of the media file to be transferred to the client; and
streaming the identified elements from the server to the client as a HTTP response.

2. A method according to claim 1, wherein parsing the request comprises determining a processing action to be applied to the elements of the media file, and wherein streaming the identified elements comprises applying the processing action to the elements.

3. A method according to claim 2, wherein parsing the request comprises determining a parameter applicable to the processing action, and wherein applying the processing action comprises processing the elements of the media file responsive to the parameter.

4. A method according to claim 3, wherein determining the parameter comprises determining a limitation on a media playing capability of the client, and wherein the processing action comprises modifying the identified elements in response to the limitation.

5. A method according to claim 4, wherein determining the limitation comprises identifying a network bandwidth, and wherein modifying the identified elements in response to the limitation comprises altering the elements responsive to the network bandwidth.

6. A method according to claim 4, wherein determining the limitation comprises determining a resource level provided by the client, and wherein modifying the identified elements comprises selecting the identified elements responsive to the resource level.

7. A method according to claim 2, wherein applying the processing action comprises transcoding at least one of the elements of the media file into a desired media format.

8. A method according to claim 1, wherein receiving the request comprises receiving a request for a certain portion of the media file, and wherein parsing the request comprises selecting the elements of the media file to be transferred responsive to the request.

9. A method according to claim 8, wherein the elements of the media file comprise an ordered sequence of frames, and wherein selecting the elements comprises selecting a segment within the sequence.

10. A method according to claim 8, wherein the elements of the media file comprises a plurality of media tracks temporally juxtaposed in parallel, and wherein selecting the elements comprises selecting, one or more of the tracks.

11. Apparatus for media streaming, comprising a server which is arranged to receive a request from a client via a network in accordance with a Hypertext Transfer Protocol (HTTP) to stream a media file of a given type, and which is further arranged to run a servlet and to pass the request to the servlet, to parse the request using the servlet to identify elements of the media file to be transferred to the client, and to steam the identified elements from the server to the client as a HTTP response.

12. Apparatus according to claim 11, wherein the server is arranged to use the servlet to parse the request so as to determine a processing action to be applied to the elements of the media file, and to apply the processing action to the elements.

13. Apparatus according to claim 12, wherein the server is arranged to use the servlet to determine a parameter applicable to the processing action, and to apply the processing action based on the parameter.

14. Apparatus according to claim 13, wherein the parameter is indicative of a limitation on a media playing capability of the client, and wherein the server is arranged to apply the processing action so as to modify the identified elements in response to the limitation.

15. Apparatus according to claim 14, wherein the limitation applies to a network bandwidth, and wherein the server is arranged to use the servlet to modify the identified elements in response to the network bandwidth.

16. Apparatus according to claim 14, wherein the limitation applies to a resource level provided by the client, and wherein the server is arranged to use the servlet to select the identified elements in response to the resource level.

17. A method according to claim 13, wherein the processing action comprises transcoding at least one of the elements of the media file into a desired media format.

18. Apparatus according to claim 11, wherein the request is for a certain portion of the media file, and wherein the server is arranged to use the servlet to parse the request so as to select the elements of the media file to be transferred responsive to the request.

19. Apparatus according to claim 18, wherein the elements of the media file comprise an ordered sequence of frames, and wherein the server is arranged to use the servlet to select a segment within the sequence responsive to the request.

20. Apparatus according to claim 18, wherein the elements of the media file comprises a plurality of media tracks temporally juxtaposed in parallel, and wherein the server is arranged to use the servlet to select one or more of the tracks responsive to the request.

21. Apparatus according to claim 11, wherein the server comprises a cluster of servers, arranged so that the HTTP request is handled by one of the servers in the cluster, and the servlet is run on a different one of the servers in the cluster.

22. A computer software product for media streaming, comprising a computer-readable medium in which program instructions are stored, which instructions, when read by a computer, cause the computer to receive a request from a client via a network in accordance with a Hypertext Transfer Protocol (HTTP) to stream a media file of a given type, and which instructions further cause the computer to run a servlet and to pass the request to the servlet, to parse the request using the servlet to identify elements of the media file to be transferred to the client, and to steam the identified elements from the server to the client as a HTTP response.

23. A product according to claim 22, wherein the instructions cause the computer to use the servlet to parse the request so as to determine a processing action to be applied to the elements of the media file, and to stream the identified elements by applying the processing action to the elements.

24. A product according to claim 23, wherein the instructions cause the computer to use the servlet to determine a parameter applicable to the processing action, and to apply the processing action based on the parameter.

25. A product according to claim 24, wherein the parameter is indicative of a limitation on a media playing capability of the client, and wherein the instructions cause the computer to apply the processing action so as to modify the identified elements in response to the limitation.

26. A product according to claim 25, wherein the limitation applies to a network bandwidth, and wherein the instructions cause the computer to use the servlet to modify the identified elements in response to the network bandwidth.

27. A product according to claim 25, wherein the limitation applies to a resource level provided by the client, and wherein the instructions cause the computer to use the servlet to select the identified elements in response to the resource level.

28. A product according to claim 24, wherein the processing action comprises transcoding at least one of the elements of the media file into a desired media format.

29. A product according to claim 22, wherein the request is for a certain portion of the media file, and wherein the instructions cause the computer to use the servlet to parse the request so as to select the elements of the media file to be transferred responsive to the request.

30. A product according to claim 29, wherein the elements of the media file comprise an ordered sequence of frames, and wherein the instructions cause the computer to use the servlet to select a segment within the sequence responsive to the request.

31. A product according to claim 29, wherein the elements of the media file comprises a plurality of media tracks temporally juxtaposed in parallel, and wherein the instructions cause the computer to use the servlet to select one or more of the tracks.

32. A product according to claim 22, wherein the servlet comprises a subset of the instructions, and the subset of the instructions comprises instructions written in a platform-independent, object-oriented computer language.
